(19) United States
(12) Patent Application Publication
(10) Pub. No.: US 2026/0107185 A1
(43) Pub. Date: Apr. 16, 2026

(54) WIRELESS COMMUNICATION DEVICES AND METHODS FOR PACKET DISCARDING

(71) Applicant: SHENZHEN TCL NEW TECHNOLOGY CO., LTD., Shenzhen, Guangdong (CN)

(72) Inventors: Liping WANG, Shenzhen, Guangdong (CN); Yincheng ZHANG, Shenzhen, Guangdong (CN)

(73) Assignee: SHENZHEN TCL NEW TECHNOLOGY CO., LTD., Shenzhen, Guangdong (CN)

(21) Appl. No.: 19/115,769

(22) PCT Filed: Sep. 29, 2022
(86) PCT No.: PCT/CN2022/122574

§ 371 Date: Mar. 26, 2025

(51) Int. Cl. H04W 28/06

(52) U.S. Cl. CPC H04W 28/06

(57) ABSTRACT

A method for packet discarding performed by a first wireless communication device includes transmitting, by the first wireless communication device, a protocol data unit (PDU) with a PDU set related information in a PDU header to a second wireless communication device, wherein the PDU set related information is used for the second wireless communication device to know which PDU set the PDU belongs to and which PDU set is its dependent PDU set; detecting, by the first wireless communication device, a PDU set based status report transmitted by the second wireless communication device when a PDU of the dependent PDU set is lost or unsuccessfully delivered; and discarding, by the first wireless communication device, a service data unit (SDU) belonging to a PDU set associated with the dependent PDU set when detecting the PDU set based status report.

### BACKGROUND OF DISCLOSURE

### 1. Field of the Disclosure

The present disclosure relates to the field of wireless communication systems, and more particularly, to wireless communication devices and wireless communication methods for packet discarding in 5G NR (new radio) communication system. More specifically, the present disclosure discusses the new Work Item for XR Enhancements for NR of Rel. 18, and this discussion maybe led by RAN2. The target of the present disclosure is to support the association processing of the traffic in 5G wireless communication system (NR, New Radio) to support XR (eXtended Reality) service which includes the representative forms such as AR (Augmented Reality), VR (Virtual Reality), or MR (Mixed Reality). Further, it is about the topic of XR-awareness in RAN. The specific XR service PDU Set related information (e.g., PDU set sequence number, PDU size and PDU set dependence etc.) provided by 5GC may be discussed.

### 2. Description of the Related Art

The 5G wireless communication system has been designed to deliver eMBB, URLLC and mMTC service. For 5G or NR, support of eMBB, URLLC and mMTC was introduced in Release 15 and enhanced in Rel 16 and 17. The eXtended Reality (XR) is a umbrella term covering Augmented Reality (AR), Mixed Reality (MR) and Virtual Reality (VR). XR applications typically require high throughput and low latency and Cloud Gaming is another application with the same requirement. XR and Cloud Gaming are important applications that may be enabled by 5G.

XR service is characterized by its special traffic streams which is real-time, high data rate and low latency. Especially for the video streams, there are different frame/video slice packets. There are some special characteristics of XR service stream which should be considered for supporting in 5G.

In prior art, for XR service, the video is one of the typical traffic for XR service, we firstly analyze the character of the video. According to the description of “IP Video Encoding Explained”, when video is encoded, the video frames are arranged in a series called a Group of Picture (GOP). A single GOP consists of an ordered sequence of one or more of the following frame types (see FIG. 1):

Intracoded frame (I frame): a frame coded independently (without reference to any other frame). The first frame in the GOP is always I frame. I frames are the largest frame type (requiring the greatest number of bits), and can be decoded on the receiving end without requiring data from any other frame.

(Forward) Predictive coded frame (P frame): a frame coded with motion changes from the most recent I or P frame. P frames are smaller than I frames.

Bidirectional Predictive coded frame (B frame): a frame coded with motion changes from the most recent I or P frame, the following I or P frame, or a combination of both. B frames require the fewest number of bits, but quality can be affected if too many B frames are used. Unlike I and P frames, B frames are never used as reference frames for encoding other frames.

The first frame in the GOP is always I frame, which is encoded independently using intraframe encoding as described in the previous section. P frames are encoded with the motion differences from the previous I or P frame. B frames can be predicted bidirectionally, using information from the nearest previous I or P frame, following I or P frame, or a combination of both (see FIG. 2).

The nature of interframe encoding means that encoding or transmission-related errors can have widely varying impact on the perceptual quality of the video, depending on which frame types in the GOP are affected (see FIG. 3). If I frame is corrupted during encoding or as a result of packet loss during transmission, the error will propagate through all remaining B and P frames in the GOP, causing distortion that may be visible for up to several seconds. An error in a P frame will propagate to any remaining B and P frames, and an error affecting a single B frame will only affect that frame (typically 15-30 ms) and may not even be noticed by the viewer.

From the above description of IP Video structure, the GoP elements (i.e., I frame, P frame, B frame) contained in the video frames have dependent relationship, which should be considered in the transmission procedure. I Frame is the most important part, should be transmitted successfully, or else the following P Frame and B Frame will be not encoded successfully. In this case, the following P Frame and B Frame which associated the I Frame will be discarded.

In addition, from the definition of PDU Set, we can see that a PDU Set is corresponding to a I Frame/P Frame/B Frame of the XR video. Thus, the PDU Sets dependence is corresponding to the I Frame/P Frame/B Frame dependence for XR service. In the above, we inferred when I Frame is wrongly received, the following P Frame/B Frame associated with the I Frame will be discarded. Thus, for RAN, when a I PDU Set is unsuccessfully received, the associated P PDU sets and B PDU sets may all be discarded. And also, if the I PDU Set is successfully received, but a P PDU set is unsuccessfully received, the associated B PDU sets may also be discarded. In other word, PDU Set in RAN should be handled in aa integrated manner.

Therefore, there is a need for wireless communication devices and wireless communication methods to discuss the XR service-specific packet discarding mechanism in RAN.

### SUMMARY

An object of the present disclosure is to propose wireless communication devices and methods for packet discarding, which discuss how to deal with the packet discarding in RAN based on the XR PDU Set related information.

In a first aspect of the present disclosure, a method for packet discarding performed by a first wireless communication device includes transmitting, by the first wireless communication device, a protocol data unit (PDU) with a PDU set related information in a PDU header to a second wireless communication device, wherein the PDU set related information is used for the second wireless communication device to know which PDU set the PDU belongs to and which PDU set is its dependent PDU set; detecting, by the first wireless communication device, a PDU set based status report transmitted by the second wireless communication device when a PDU of the dependent PDU set is lost or unsuccessfully delivered, wherein the PDU set based status report indicates that the dependent PDU set is lost or unsuccessfully delivered; and discarding, by the first wireless communication device, a service data unit (SDU) belonging to a PDU set associated with the dependent PDU set when detecting the PDU set based status report; wherein the method for packet discarding is performed by a packet data convergence protocol (PDCP) entity or a radio link control (RLC) entity of the first wireless communication device.

In a second aspect of the present disclosure, a method for packet discarding performed by a second wireless communication device includes detecting, by the second wireless communication device, a protocol data unit (PDU) with a PDU set related information in a PDU header transmitted by a first wireless communication device, wherein the PDU set related information is used for the second wireless communication device to know which PDU set the PDU belongs to and which PDU set is its dependent PDU set; transmitting, by the second wireless communication device, a PDU set based status report to the first wireless communication device when a PDU of the dependent PDU set is lost or unsuccessfully delivered, wherein the PDU set based status report indicates that the dependent PDU set is lost or unsuccessfully delivered; and controlling the first wireless communication device to discard a service data unit (SDU) belonging to a PDU set associated with the dependent PDU set when detecting the PDU set based status report; wherein the method for packet discarding is performed by a packet data convergence protocol (PDCP) entity or a radio link control (RLC) entity of the second wireless communication device.

In a third aspect of the present disclosure, a first wireless communication device includes a memory, a transceiver, and a processor coupled to the memory and the transceiver. The processor is configured to execute the above method.

In a fourth aspect of the present disclosure, a second wireless communication device includes a memory, a transceiver, and a processor coupled to the memory and the transceiver. The processor is configured to execute the above method.

In a fifth aspect of the present disclosure, a non-transitory machine-readable storage medium has stored thereon instructions that, when executed by a computer, cause the computer to perform the above method.

In a sixth aspect of the present disclosure, a chip includes a processor, configured to call and run a computer program stored in a memory, to cause a device in which the chip is installed to execute the above method.

In a seventh aspect of the present disclosure, a computer readable storage medium, in which a computer program is stored, causes a computer to execute the above method.

In an eighth aspect of the present disclosure, a computer program product includes a computer program, and the computer program causes a computer to execute the above method.

In a nineth aspect of the present disclosure, a computer program causes a computer to execute the above method.

### BRIEF DESCRIPTION OF DRAWINGS

In order to illustrate the embodiments of the present disclosure or related art more clearly, the following figures will be described in the embodiments are briefly introduced. It is obvious that the drawings are merely some embodiments of the present disclosure, a person having ordinary skill in this field can obtain other figures according to these figures without paying the premise.

FIG. 1 is a schematic diagram illustrating a typical GOP structure.

FIG. 2 is a schematic diagram illustrating P and B frame coding dependencies.

FIG. 3 is a schematic diagram illustrating error propagation through the GOP.

FIG. 4 is a block diagram of first and second wireless communication devices of communication in a communication network system according to an embodiment of the present disclosure.

FIG. 5 is a flowchart illustrating a method for packet discarding performed by a first wireless communication device according to an embodiment of the present disclosure.

FIG. 6 is a flowchart illustrating a method for packet discarding performed by a second wireless communication device according to an embodiment of the present disclosure.

FIG. 7 is a schematic diagram illustrating an example of associated PDU sets of one GOP mapped to the same DRB according to an embodiment of the present disclosure.

FIG. 8 is a schematic diagram illustrating an example of PDCP PDU Set based PDCP status reporting according to an embodiment of the present disclosure.

FIG. 9 is a schematic diagram illustrating an example of associated PDU sets of one GOP mapped to different DRBs according to an embodiment of the present disclosure.

FIG. 10 is a schematic diagram illustrating an example of RRC reconfiguration procedure according to an embodiment of the present disclosure.

FIG. 11 is a schematic diagram illustrating an example of PDCP PDU Set based PDCP status reporting according to an embodiment of the present disclosure.

FIG. 12 is a schematic diagram illustrating an example of associated PDU sets of one GOP mapped to the same DRB according to an embodiment of the present disclosure.

FIG. 13 is a block diagram of a first wireless communication device according to an embodiment of the present disclosure.

FIG. 14 is a block diagram of a second wireless communication device according to an embodiment of the present disclosure.

FIG. 15 is a block diagram of a system for wireless communication according to an embodiment of the present disclosure.

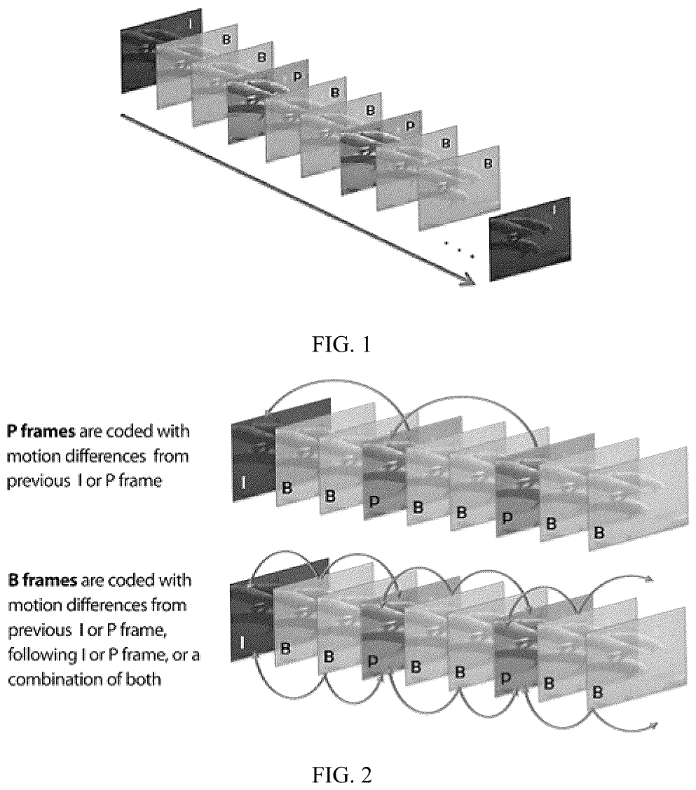

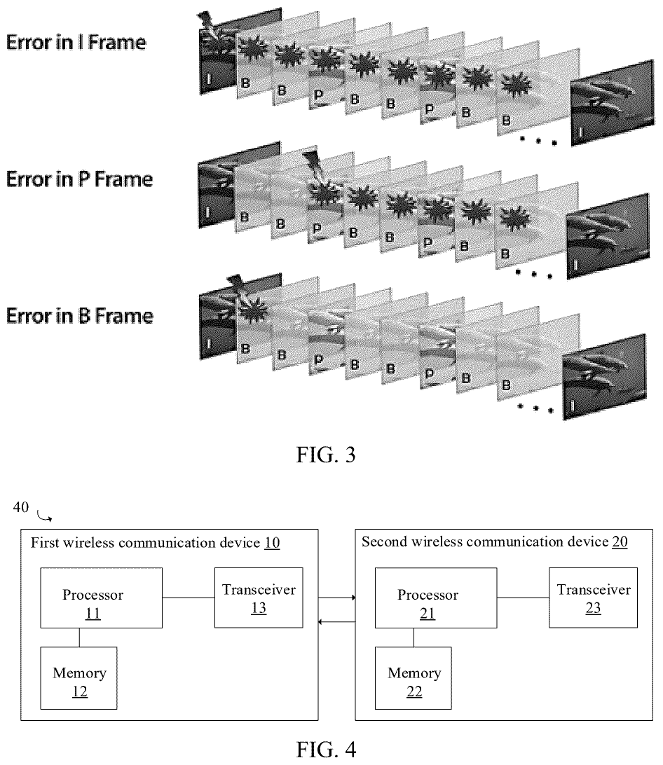

### DETAILED DESCRIPTION OF EMBODIMENTS

Embodiments of the present disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

FIG. 4 illustrates that, in some embodiments, first and second wireless communication device 10 and 20 for communication in a communication network system 40 according to an embodiment of the present disclosure are provided. The communication network system 40 includes the first and second wireless communication device 10 and 20. The first wireless communication device 10 may include a memory 12, a transceiver 13, and a processor 11 coupled to the memory 12 and the transceiver 13. The second wireless communication device 20 may include a memory 22, a transceiver 23, and a processor 21 coupled to the memory 22 and the transceiver 23. The processor 11 or 21 may be configured to implement proposed functions, procedures and/or methods described in this description. Layers of radio interface protocol may be implemented in the processor 11 or 21. The memory 12 or 22 is operatively coupled with the processor 11 or 21 and stores a variety of information to operate the processor 11 or 21. The transceiver 13 or 23 is operatively coupled with the processor 11 or 21, and the transceiver 13 or 23 transmits and/or receives a radio signal.

The processor 11 or 21 may include application-specific integrated circuit (ASIC), other chipset, logic circuit and/or data processing device. The memory 12 or 22 may include read-only memory (ROM), random access memory (RAM), flash memory, memory card, storage medium and/or other storage device. The transceiver 13 or 23 may include baseband circuitry to process radio frequency signals. When the embodiments are implemented in software, the techniques described herein can be implemented with modules (e.g., procedures, functions, and so on) that perform the functions described herein. The modules can be stored in the memory 12 or 22 and executed by the processor 11 or 21. The memory 12 or 22 can be implemented within the processor 11 or 21 or external to the processor 11 or 21 in which case those can be communicatively coupled to the processor 11 or 21 via various means as is known in the art.

In some embodiments, the transceiver 13 is configured to transmit a protocol data unit (PDU) with a PDU set related information in a PDU header to the second wireless communication device 20, wherein the PDU set related information is used for the second wireless communication device 20 to know which PDU set the PDU belongs to and which PDU set is its dependent PDU set. The processor 11 is configured to detect a PDU set based status report transmitted by the second wireless communication device 20 when a PDU of the dependent PDU set is lost or unsuccessfully delivered, wherein the PDU set based status report indicates that the dependent PDU set is lost or unsuccessfully delivered. The processor 11 is further configured to discard a service data unit (SDU) belonging to a PDU set associated with the dependent PDU set when detecting the PDU set based status report. The method for packet discarding can be performed by a packet data convergence protocol (PDCP) entity or a radio link control (RLC) entity of the first wireless communication device 10. This can save the transmission radio resource for XR service.

In some embodiments, the processor 21 is configured to detect a protocol data unit (PDU) with a PDU set related information in a PDU header transmitted by the first wireless communication device 10, wherein the PDU set related information is used for the second wireless communication device 20 to know which PDU set the PDU belongs to and which PDU set is its dependent PDU set. The transceiver 23 is configured to transmit a PDU set based status report to the first wireless communication device 10 when a PDU of the dependent PDU set is lost or unsuccessfully delivered, wherein the PDU set based status report indicates that the dependent PDU set is lost or unsuccessfully delivered. The processor 21 is further configured to control the first wireless communication device 10 to discard a service data unit (SDU) belonging to a PDU set associated with the dependent PDU set when detecting the PDU set based status report. The method for packet discarding can be performed by a packet data convergence protocol (PDCP) entity or a radio link control (RLC) entity of the second wireless communication device 20. This can save the transmission radio resource for XR service.

FIG. 5 illustrates a method for packet discarding performed by a first wireless communication device according to an embodiment of the present disclosure. In some embodiments, the method 500 includes: a block 502, transmitting, by the first wireless communication device, a protocol data unit (PDU) with a PDU set related information in a PDU header to a second wireless communication device, wherein the PDU set related information is used for the second wireless communication device to know which PDU set the PDU belongs to and which PDU set is its dependent PDU set; a block 504, detecting, by the first wireless communication device, a PDU set based status report transmitted by the second wireless communication device when a PDU of the dependent PDU set is lost or unsuccessfully delivered, wherein the PDU set based status report indicates that the dependent PDU set is lost or unsuccessfully delivered; and a block 506, discarding, by the first wireless communication device, a service data unit (SDU) belonging to a PDU set associated with the dependent PDU set when detecting the PDU set based status report; wherein the method for packet discarding is performed by a packet data convergence protocol (PDCP) entity or a radio link control (RLC) entity of the first wireless communication device. This can save the transmission radio resource for XR service.

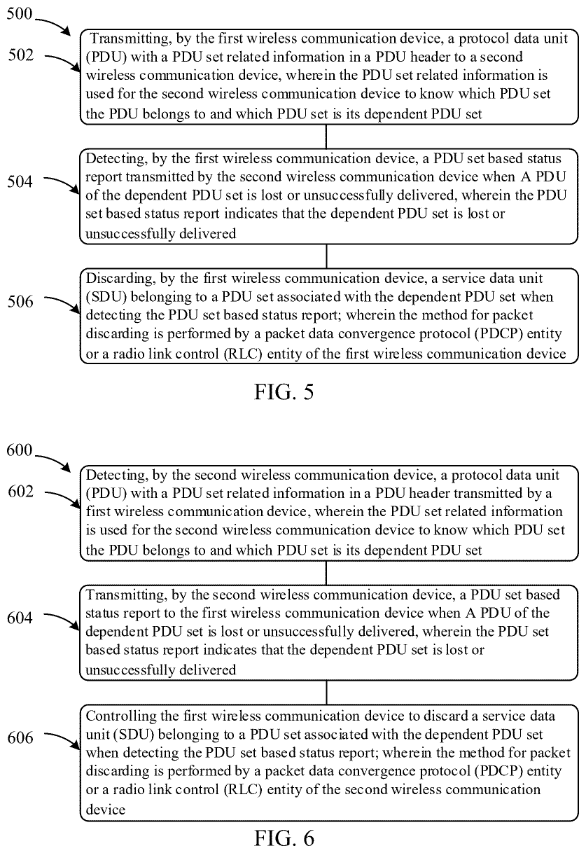

FIG. 6 illustrates a method for packet discarding performed by a second wireless communication device according to an embodiment of the present disclosure. In some embodiments, the method 600 includes: a block 602, detecting, by the second wireless communication device, a protocol data unit (PDU) with a PDU set related information in a PDU header transmitted by a first wireless communication device, wherein the PDU set related information is used for the second wireless communication device to know which PDU set the PDU belongs to and which PDU set is its dependent PDU set; a block 604, transmitting, by the second wireless communication device, a PDU set based status report to the first wireless communication device when a PDU of the dependent PDU set is lost or unsuccessfully delivered, wherein the PDU set based status report indicates that the dependent PDU set is lost or unsuccessfully delivered; and a block 606, controlling the first wireless communication device to discard a service data unit (SDU) belonging to a PDU set associated with the dependent PDU set when detecting the PDU set based status report; wherein the method for packet discarding is performed by a packet data convergence protocol (PDCP) entity or a radio link control (RLC) entity of the second wireless communication device. This can save the transmission radio resource for XR service.

### Embodiment 1

In this embodiment, we mainly consider XR service-specific packet discarding mechanism in RAN PDCP layer.

To be specific, when the unsuccessfully delivery of a dependent PDCP PDU Set is confirmed by PDU Set based PDCP status report, which is based on the granularity of PDCP PDU Set and is sent by the receiving PDCP entity, the transmitting PDCP entity shall discard the PDCP SDU belongs to the PDU Set which is associated with the dependent PDCP PDU Set. If the corresponding PDCP Data PDU has already been submitted to lower layers, the discard is indicated to lower layers. For example, when receiving PDCP entity inform that the I PDU set is lost by PDU Set based PDCP status report, the transmitting PDCP entity shall discard the PDCP SDU contained in the P PDU set and B PDU set, which is associated with the I PDU set, i.e., the packet included in P PDU set and B PDU set are dependent on the packet included in I PDU set.

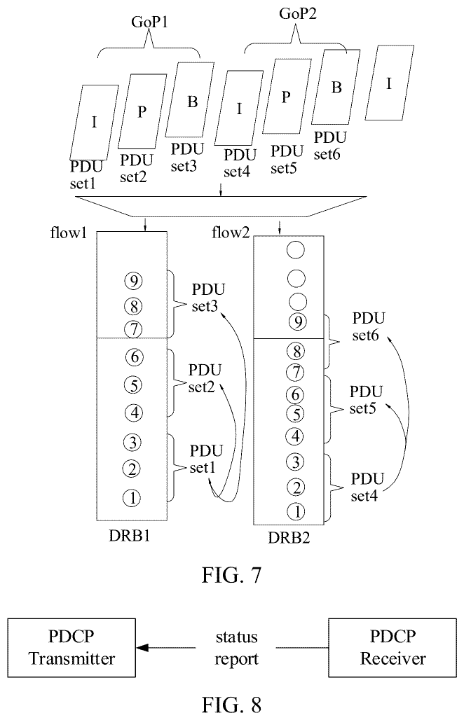

In this embodiment, associated PDU Sets of XR service are mapped to the same DRB, i.e., the Centralized DRB mapping are used. FIG. 7 is a schematic diagram illustrating an example of associated PDU sets of one GOP mapped to the same DRB according to an embodiment of the present disclosure. As shown in FIG. 7, all the PDU sets of Gop1 are mapped to the same DRB1, all the PDU sets of Gop2 are mapped to the same DRB2. (NOTE: For easier explanation, we take the Gop-based model as example in the following chapters, and the PDU sets contained in one Gop are I PDU Set, P PDU Sets and B PDU Sets.)

As we discussed above, the dependence relationship of PDU Sets of one Gop is as follows:

The decoding of P PDU Set relay on the I PDU Set. The decoding of B PDU Set relay on the I PDU Set and the P PDU Set.

Thus, we can infer for the transmitter in RAN:

If the I PDU Set is lost or unsuccessfully delivered, the associated P PDU Set and B PDU Set should be discarded. If the P PDU Set is lost or unsuccessfully delivered, the associated B PDU Set should be discarded.

For packet discarding of XR service, to support the PDU Set based packet discarding scheme, and the following enhancements for PDCP layer are needed:

1. Enhancement of PDCP Data PDU for DRBs. To be specific, we need to add PDU set related information in the PDCP PDU header for the transmitter, which is used by the receiving PDCP entity to determine whether dependent PDCP PDU Set are unsuccessfully delivered. When dependent PDCP PDU Set is lost, the receiving PDCP entity may send a PDCP status report to the transmitting PDCP entity.

The PDU set related information includes at least one of the followings:

PDU Set type: This field indicates whether the type of the corresponding PDU Set is an I PDU Set or a P PDU Set, or a B PDU Set.

PDU Set Sequence Number: This field indicates the Number of the corresponding PDU Set.

PDU Sequence Number in a PDU Set: This field indicates the Number of the corresponding PDU contained in the PDU set.

Packet priority in a PDU Set: This field indicates whether the corresponding PDU contained in a PDU set have highest priority.

PI: This field indicates whether the corresponding PDU contained in a PDU set is the first packet, or the last packet, or the packet between the first packet and the last packet.

Dependent PDU Set Sequence Number: This field indicates the dependent PDU Set Sequence Number of the corresponding PDU Set.

2. Enhancement of PDCP status report. To be specific, a PDU Set based PDCP status report is introduced. When dependent PDCP PDU Set is lost, the receiving PDCP entity may send a PDCP status report to the transmitting PDCP entity (See FIG. 8). FIG. 8 is a schematic diagram illustrating an example of PDCP PDU Set based PDCP status reporting according to an embodiment of the present disclosure. Based on the PDCP status report, the transmitting PDCP entity shall discard the PDCP SDU belongs to the PDU Set which is associated with the dependent PDCP PDU Set.

### PDU Set Based PDCP Status Reporting:

### Transmit Operation:

For AM DRBs or UM DRBs configured by upper layers to send a PDU Set based PDCP status report, the receiving PDCP entity shall trigger a PDCP status report when: dependent PDCP PDU Set is lost; and/or t-Reordering expires. If a PDU Set based PDCP status report is triggered, the receiving PDCP entity shall: compile a PDU Set based PDCP status report as indicated below by: setting the FMP (first mission packet) field to the first unsuccessfully received PDU Set Sequence Number; setting in the bitmap field as ‘0’ for not all PDCP SDUs of the PDU Set that have been received, and optionally PDCP SDUs for which decompression have failed; setting in the bitmap field as ‘1’ for all PDCP SDUs of the PDU Set that have been received; and/or submitting the PDU Set based PDCP status report to lower layers as the first PDCP PDU for transmission via the transmitting PDCP entity.

### Receive Operation:

For AM DRBs or UM DRBs, when a PDU Set PDCP status report is received, the transmitting PDCP entity shall: consider for each PDU Set, if any, with the bit in the bitmap set to ‘1’, or with the dependent PDU Set Sequence Number value less than the value of FMP field as successfully delivered; and/or consider for each PDU Set, if any, with the bit in the bitmap set to ‘0’ as unsuccessfully delivered. If the PDU Set type of the unsuccessfully delivered PDU Set is an “I PDU Set type”, discard all the PDCP SDUs of the associated PDU Set according to the dependent PDU Set Sequence Number.

### Embodiment 2

In this embodiment, we mainly consider XR service-specific packet discarding mechanism in RAN PDCP layer.

To be specific, when the unsuccessfully delivery of a dependent PDCP PDU Set is confirmed by PDU Set based PDCP status report, which is based on the granularity of PDCP PDU Set and is sent by the receiving PDCP entity, the transmitting PDCP entity shall discard the PDCP SDU belongs to the PDU Set which is associated with the dependent PDCP PDU Set. If the corresponding PDCP Data PDU has already been submitted to lower layers, the discard is indicated to lower layers. For example, when receiving PDCP entity inform that the I PDU set is lost by PDU Set based PDCP status report, the transmitting PDCP entity shall discard the PDCP SDU contained in the P PDU set and B PDU set, which is associated with the I PDU set, i.e., the packet included in P PDU set and B PDU set are dependent on the packet included in I PDU set.

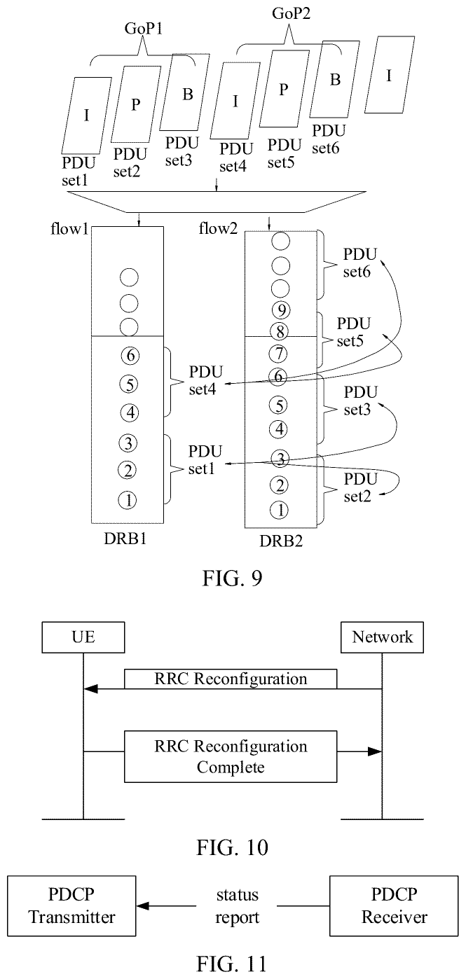

In this embodiment, associated PDU Sets of XR service are mapped to different DRB, i.e., the distribute DRB mapping mechanism are used. FIG. 9 is a schematic diagram illustrating an example of associated PDU sets of one GOP mapped to different DRBs according to an embodiment of the present disclosure. As shown in FIG. 9, all the I PDU sets of Gop1 and Gop2 are mapped to DRB1, all the P PDU sets B PDU sets of Gop1 and Gop2 are mapped to DRB2. (NOTE: For easier explanation, we take the Gop-based model as example in the following chapters, and the PDU sets contained in one Gop are I PDU Set, P PDU Sets and B PDU Sets.)

As we discussed above, the dependence relationship of PDU Sets of one Gop is as follows:

The decoding of P PDU Set relay on the I PDU Set. The decoding of B PDU Set relay on the I PDU Set and the P PDU Set.

Thus, we can infer for the transmitter in RAN:

If the I PDU Set in DRB1 is lost or unsuccessfully delivered, the associated P PDU Set and B PDU Set in DRB2 should be discarded. If the P PDU Set in DRB2 is lost or unsuccessfully delivered, the associated B PDU Set in DRB2 should be discarded.

For packet discarding of XR service, to support the PDU Set based packet discarding scheme, and the following enhancements for PDCP layer are needed:

1. Enhancement of PDCP Data PDU for DRBs. To be specific, we need to add PDU sets related information in the PDCP PDU header for the transmitter, which is used by the receiving PDCP entity to judge whether dependent PDCP PDU Set are unsuccessfully delivered. When dependent PDCP PDU Set is lost, the receiving PDCP entity will send a PDCP status report to the transmitting PDCP entity.

The PDU sets related information includes at least one of the followings:

PDU Set type: This field indicates whether the type of the corresponding PDU Set is an I PDU Set or a P PDU Set, or a B PDU Set.

PDU Set Sequence Number: This field indicates the Number of the corresponding PDU Set.

PDU Sequence Number in a PDU Set: This field indicates the Number of the corresponding PDU contained in the PDU set.

Packet priority in a PDU Set: This field indicates whether the corresponding PDU contained in a PDU set have highest priority.

PI: This field indicates whether the corresponding PDU contained in a PDU set is the first packet, or the last packet, or the packet between the first packet and the last packet.

Dependent DRB ID: This field indicates the dependent DRB ID which the PDU Set allocates. For example, the PDU Set2 allocates in DRB2, the dependent PDU set1 allocates in DRB1, so the dependent DRB ID is DRB1.

Dependent PDU Set Sequence Number: This field indicates the dependent PDU Set Sequence Number of the corresponding PDU Set.

Optional, the dependent DRB ID can be configured by control plane mechanism. FIG. 10 is a schematic diagram illustrating an example of RRC reconfiguration procedure according to an embodiment of the present disclosure. To be specific, the network can use RRC Reconfiguration procedure to inform UE the dependent DRB I when a DRB is established (See FIG. 10).

### RadioBearerConfig:

The IE RadioBearerConfig is used to add, modify and release signalling and/or data radio bearers. Specifically, this IE carries the parameters for PDCP and, if applicable, SDAP entities for the radio bearers.

```
  RadioBearerConfig information element
  -- ASN1START
  -- TAG-RADIOBEARERCONFIG-START
```

| | |
|---|---|
| RadioBearerConfig ::= | SEQUENCE { |
| srb-ToAddModList | SRB-ToAddModList |

OPTIONAL, -- Cond HO-Conn

| | |
|---|---|
| srb3-ToRelease | ENUMERATED{true} |

OPTIONAL, -- Need N

| | |
|---|---|
| drb-ToAddModList | DRB-ToAddModList |

OPTIONAL, -- Cond HO-toNR

| | |
|---|---|
| drb-ToReleaseList | DRB-ToReleaseList |

OPTIONAL, -- Need N

| | |
|---|---|
| securityConfig | SecurityConfig |

```
OPTIONAL, -- Need M
    ...
  }
```

| | |
|---|---|
| SRB-ToAddModList ::= | SEQUENCE (SIZE (1..2)) OF SRB-ToAddMod |
| SRB-ToAddMod ::= | SEQUENCE { |
| srb-Identity | SRB-Identity, |
| reestablishPDCP | ENUMERATED{true} |

OPTIONAL, -- Need N

| | |
|---|---|
| discardOnPDCP | ENUMERATED{true} |

OPTIONAL, -- Need N

| | |
|---|---|
| pdcp-Config | PDCP-Config |

```
OPTIONAL, -- Cond PDCP
    ...
  }
```

| | |
|---|---|
| DRB-ToAddModList ::= | SEQUENCE (SIZE (1..maxDRB)) OF DRB-ToAddMod |
| DRB-ToAddMod ::= | SEQUENCE { |
| cnAssociation | CHOICE { |
| eps-BearerIdentity | INTEGER (0..15), |
| sdap-Config | SDAP-Config |

}
OPTIONAL, -- Cond DRBSetup

| | |
|---|---|
| drb-Identity | DRB-Identity, |
| dependent-drb-Identity | dependent-DRB-Identity, |
| reestablishPDCP | ENUMERATED{true} |

OPTIONAL, -- Need N

| | |
|---|---|
| recoverPDCP | ENUMERATED{true} |

OPTIONAL, -- Need N

| | |
|---|---|
| pdcp-Config | PDCP-Config |

```
OPTIONAL, -- Cond PDCP
    ...,
    [[
```

| | |
|---|---|
| daps-Config-r16 | ENUMERATED{true} |

```
OPTIONAL -- Cond DAPS
    ]]
  }
```

| | |
|---|---|
| DRB-ToReleaseList ::= | SEQUENCE (SIZE (1..maxDRB)) OF DRB-Identity |
| SecurityConfig ::= | SEQUENCE { |
| securityAlgorithmConfig | SecurityAlgorithmConfig |

OPTIONAL, -- Cond RBTermChange1

| | |
|---|---|
| keyToUse | ENUMERATED{master, secondary} |

```
OPTIONAL, -- Cond RBTermChange
    ...
  }
  -- TAG-RADIOBEARERCONFIG-STOP
-- ASN1STOP
```

2. Enhancement of PDCP status report. To be specific, a PDU Set based PDCP status report are introduced. When dependent PDCP PDU Set is lost, the receiving PDCP entity will send a PDCP status report to the transmitting PDCP entity (See FIG. 11). Based on the PDCP status report, the transmitting PDCP entity will inform the associated transmitting PDCP entity of the lost dependent PDCP PDU Set according to “dependent DRB ID”. Then the associated transmitting PDCP entity shall discard the PDCP SDU belongs to the PDU Set which is associated with the dependent PDCP PDU Set.

### PDU Set Based PDCP Status Reporting:

### Transmit Operation:

For AM DRBs or UM DRBs configured by upper layers to send a PDU Set based PDCP status report, the receiving PDCP entity shall trigger a PDCP status report when: dependent PDCP PDU Set is lost; and/or t-Reordering expires.

If a PDU Set based PDCP status report is triggered, the receiving PDCP entity shall: compile a PDU Set based PDCP status report as indicated below by: setting the FMP field to the first unsuccessfully received PDU Set Sequence Number; setting in the bitmap field as ‘0’ for not all PDCP SDUs of the PDU Set that have been received, and optionally PDCP SDUs for which decompression have failed; setting in the bitmap field as ‘1’ for all PDCP SDUs of the PDU Set that have been received; and/or submitting the PDU Set based PDCP status report to lower layers as the first PDCP PDU for transmission via the transmitting PDCP entity.

### Receive Operation:

For AM DRBs or UM DRBs, when a PDU Set PDCP status report is received, the transmitting PDCP entity shall: consider for each PDU Set, if any, with the bit in the bitmap set to ‘1’, or with the dependent PDU Set Sequence Number value less than the value of FMP field as successfully delivered; and/or consider for each PDU Set, if any, with the bit in the bitmap set to ‘0’ as unsuccessfully delivered. If the PDU Set type of the unsuccessfully delivered PDU Set is an “I PDU Set type”, discard all the PDCP SDUs of the associated PDU Set belongs to the associated DRB according to the “dependent DRB ID” and the “dependent PDU Set Sequence Number”.

### Embodiment 3

In this embodiment, we mainly consider XR service-specific packet discarding mechanism in RAN RLC layer.

To be specific, when the unsuccessfully delivery of a dependent RLC PDU Set is confirmed by RLC status report, which is sent by the receiving RLC entity, the transmitting RLC entity shall discard the RLC SDU belongs to the PDU Set which is associated with the dependent RLC PDU Set. For example, when receiving RLC entity inform that the I PDU set is lost by RLC status report, the transmitting RLC entity shall discard the RLC SDU contained in the P PDU set and B PDU set, which is associated with the I PDU set, i.e., the packet included in P PDU set and B PDU set are dependent on the packet included in I PDU set.

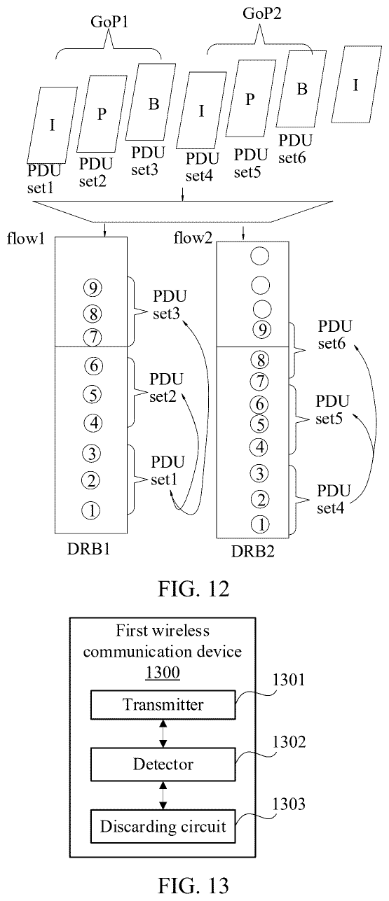

In this embodiment, associated PDU Sets of XR service are mapped to the same DRB, i.e., the Centralized DRB mapping are used. FIG. 12 is a schematic diagram illustrating an example of associated PDU sets of one GOP mapped to the same DRB according to an embodiment of the present disclosure according to an embodiment of the present disclosure. As shown in FIG. 12, all the PDU sets of Gop1 are mapped to the same DRB1, all the PDU sets of Gop2 are mapped to the same DRB2. (NOTE: For easier explanation, we take the Gop-based model as example in the following chapters, and the PDU sets contained in one Gop are I PDU Set, P PDU Sets and B PDU Sets.)

As we discussed above, the dependence relationship of PDU Sets of one Gop is as follows:

The decoding of P PDU Set relay on the I PDU Set; and/or the decoding of B PDU Set relay on the I PDU Set and the P PDU Set.

Thus, we can infer for the transmitter in RAN: If the I PDU Set is lost or unsuccessfully delivered, the associated P PDU Set and B PDU Set should be discarded. If the P PDU Set is lost or unsuccessfully delivered, the associated B PDU Set should be discarded.

For packet discarding of XR service, to support the PDU Set based packet discarding scheme, and the following enhancements for RLC layer are needed:

1. Enhancement of RLC Data PDU for DRBs. To be specific, we need to add PDU sets related information in the RLC PDU header for the transmitter, which is used by the receiving RLC entity to judge whether dependent RLC PDU Set are unsuccessfully delivered. When dependent RLC PDU Set is lost, the receiving RLC entity will send a RLC status report to the transmitting RLC entity.

The PDU sets related information includes at least one of the followings:

PDU Set type: This field indicates whether the type of the corresponding PDU Set is an I PDU Set or a P PDU Set, or a B PDU Set.

PDU Set Sequence Number: This field indicates the Number of the corresponding PDU Set.

PDU Sequence Number in a PDU Set: This field indicates the Number of the corresponding PDU contained in the PDU set.

Packet priority in a PDU Set: This field indicates whether the corresponding PDU contained in a PDU set have highest priority.

PI: This field indicates whether the corresponding PDU contained in a PDU set is the first packet, or the last packet, or the packet between the first packet and the last packet.

dependent PDU Set Sequence Number: This field indicates the dependent PDU Set Sequence Number of the corresponding PDU Set.

Further, since the RAN can be a Cu-DU separated architecture, the above PDU sets related info should also be transmitted on F1-U interface. Thus, we also need to add PDU sets related info in the F1-U header for the transmitter.

2. Enhancement of RLC status report. To be specific, the RLC Status report is used for both RLC AM DRBs and RLC UM DRBs. When dependent RLC PDU Set is lost, the receiving RLC entity will send a RLC status report to the transmitting RLC entity. Based on the RLC status report, the transmitting RLC entity shall discard the RLC SDU belongs to the PDU Set which is associated with the dependent RLC PDU Set.

### RLC Status Reporting:

### Transmit Operation:

An AM RLC entity or UM RLC entity sends STATUS PDUs to its peer AM RLC entity or UM RLC entity in order to provide positive and/or negative acknowledgements of RLC SDUs (or portions of them).

Triggers to initiate STATUS reporting include that dependent RLC PDU Set is lost; and/or receive operation.

When STATUS reporting has been triggered, the receiving side of an AM RLC entity or UM RLC entity shall: consider for each RLC PDU of the PDU Set, if any, ‘NACK_SN’ as unsuccessfully delivered. If the PDU Set type of the PDU Set which the unsuccessfully delivered RLC PDU belongs to is an “I PDU Set type”, discard all the RLC SDUs of the associated PDU Set according to the dependent PDU Set Sequence Number.

In summary, to support the requirement of packet discarding in RAN base on PDU Set dependence, a grouping method for supporting the packet discarding is disclosed. Both PDCP layer packet discarding and RLC layer packet discarding are considered. And the following associated enhancements are provided: adding the PDU Set dependence information in the PDCP header, and/or the RLC header or and/F1-U GTP-U header for the XR PDU set associated DRB on Uu, introducing the PDU Set granularity PDCP STATUS report, and/or introducing the RLC STATUS report for RLC UM RLC entity. The PDU Set dependent information includes at least one of the below: The PDU Set SN, Start and/or End of the PDU Set, PDU SN within a PDU Set, Number of PDUs within a PDU Set, PDU Set importance and/or dependency, Packet priority in a PDU Set, PI, dependent DRB ID, and/or dependent PDU Set Sequence Number. For the purposes of some embodiments of the present disclosure, the following symbols apply: PSDB: PDU-Set Delay Budget and PSER: PDU-Set Error Rate.

FIG. 13 is a block diagram of a first wireless communication device 1300 according to an embodiment of the present disclosure. The wireless communication device 1300 includes a transmitter 1301 configured to transmit a protocol data unit (PDU) with a PDU set related information in a PDU header to a second wireless communication device, wherein the PDU set related information is used for the second wireless communication device to know which PDU set the PDU belongs to and which PDU set is its dependent PDU set; a detector 1302 configured to detecting a PDU set based status report transmitted by the second wireless communication device when a PDU of the dependent PDU set is lost or unsuccessfully delivered, wherein the PDU set based status report indicates that the dependent PDU set is lost or unsuccessfully delivered; and a discarding circuit 1303 configured to discard a service data unit (SDU) belonging to a PDU set associated with the dependent PDU set when detecting the PDU set based status report; wherein the method for packet discarding is performed by a packet data convergence protocol (PDCP) entity or a radio link control (RLC) entity of the first wireless communication device.

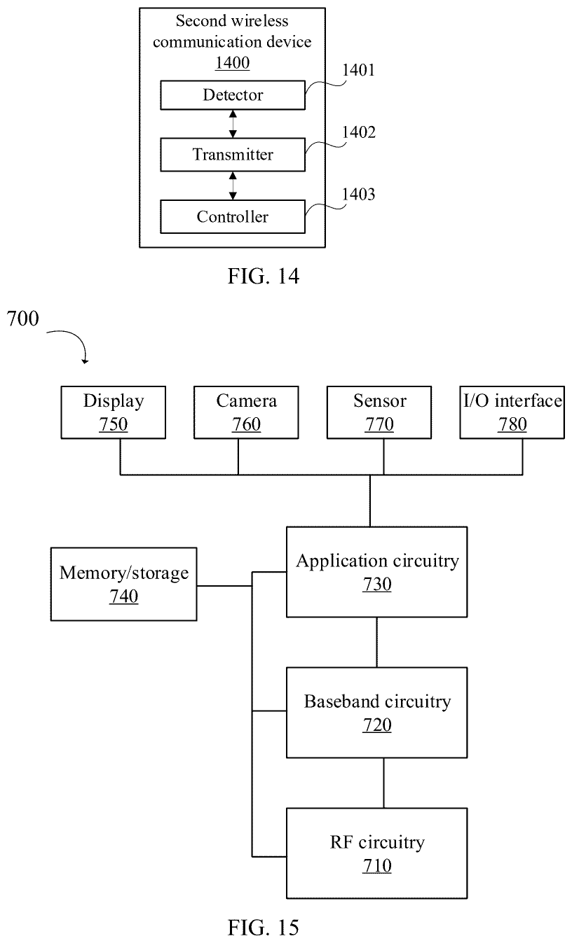

FIG. 14 is a block diagram of a second wireless communication device 1400 according to an embodiment of the present disclosure. The wireless communication device 1400 includes a detector 1401 configured to detect a protocol data unit (PDU) with a PDU set related information in a PDU header transmitted by a first wireless communication device, wherein the PDU set related information is used for the second wireless communication device to know which PDU set the PDU belongs to and which PDU set is its dependent PDU set; a transmitter 1402 configured to transmit a PDU set based status report to the first wireless communication device when a PDU of the dependent PDU set is lost or unsuccessfully delivered, wherein the PDU set based status report indicates that the dependent PDU set is lost or unsuccessfully delivered; and a controller configured to control the first wireless communication device to discard a service data unit (SDU) belonging to a PDU set associated with the dependent PDU set when detecting the PDU set based status report; wherein the method for packet discarding is performed by a packet data convergence protocol (PDCP) entity or a radio link control (RLC) entity of the second wireless communication device.

In some embodiments, the dependent PDU set comprises at least one I PDU set, at least one P PDU set, and at least one B PDU set, when the at least one I PDU set is lost or unsuccessfully delivered, at least one associated P PDU set and/or at least one associated B PDU set is discarded, or when the at least one P PDU set is lost or unsuccessfully delivered, the at least one associated B PDU set is discarded. In some embodiments, the PDU set related information comprises at least one of the followings: a PDU set type, a PDU set sequence number (SN), a start and/or an end of the PDU set, the PDU SN within the PDU set, a number of PDUs within the PDU set, a PDU set importance and/or dependency, a packet priority in the PDU set, a position indicator (PI), an associated data radio bearer (DRB) identifier (ID), and a dependent PDU set SN.

In some embodiments, associated PDU sets are mapped to the same DRB or different DRBs. In some embodiments, when the associated PDU sets are mapped to the same DRB and the method for packet discarding is performed by the PDCP entity of the first wireless communication device, the PDU set related information comprises at least one of the followings: the PDU set type, the PDU set SN, the PDU SN within the PDU set, the packet priority in the PDU set, the PI, and the dependent PDU set SN. In some embodiments, when the associated PDU sets are mapped to the different DRBs and the method for packet discarding is performed by the PDCP entity of the first wireless communication device, the PDU set related information comprises at least one of the followings: the PDU set type, the PDU set SN, the PDU SN within the PDU set, the packet priority in the PDU set, the PI, the dependent DRB ID, and the dependent PDU set SN. In some embodiments, the dependent DRB ID is configured by a control plane mechanism. In some embodiments, a radio resource control (RRC) reconfiguration procedure is used by one of the first wireless communication device and the second wireless communication device to inform the dependent DRB ID to the other of the first wireless communication device and the second wireless communication device wherein a DRB is established.

In some embodiments, based on the PDU set based status report, the PDCP entity of the first wireless communication device is configured to inform an associated transmitting PDCP entity of the lost dependent PDCP PDU set according to the dependent DRB ID. In some embodiments, the associated transmitting PDCP entity is configured to discard the PDCP SDU belonging to the PDU set associated with the dependent PDCP PDU set. In some embodiments, for acknowledged mode (AM) DRBs or unacknowledged mode (UM) DRBs configured by at least one upper layer to send the PDU set based status report by the second wireless communication device, the PDU set based status report is triggered by the second wireless communication device when the dependent PDU set is lost or unsuccessfully delivered and/or t-Reordering expires.

In some embodiments, when the PDU set based status report is triggered by the second wireless communication device, at least one following operation is performed by the second wireless communication device: compiling the PDU set based status report by: setting a first mission packet (FMP) field to a first unsuccessfully received PDU set SN; setting in a bitmap field as a first value for not all PDCP SDUs of the PDU set that have been received or the PDCP SDUs for which decompression have failed; setting in the bitmap field as a second value for all PDCP SDUs of the PDU set that have been received or lost; and/or submitting the PDU set based status report to at least one lower layer as a first PDCP PDU for transmission via the PDCP entity of the first wireless communication device.

In some embodiments, for AM DRBs or UM DRBs, when the PDU set based status report is received by the first wireless communication device, at least one following operation is performed by the first wireless communication device: considering for each PDU set, if any, with a bit in the bitmap set to a first value as unsuccessfully delivered or lost; considering for each PDU set, if any, with a bit in a bitmap set to a second value, or with a dependent PDU set SN value less than a value of an FMP field as successfully delivered or lost; and/or when a PDU set type of an unsuccessfully delivered or lost PDU set is an I PDU set type, discarding all the PDCP SDUs of the associated PDU set according to the dependent PDU set SN when the associated PDU sets are mapped to the same DRB or discarding all the PDCP SDUs of the associated PDU set belonging to the associated DRB according to the dependent DRB ID and the dependent PDU set SN when the associated PDU sets are mapped to the different DRBs.

In some embodiments, when the method for packet discarding is performed by the RLC entity of the first wireless communication device, the PDU set related information comprises at least one of the followings: the PDU set type, the PDU set SN, the PDU SN within the PDU set, the packet priority in the PDU set, the PI, and the dependent PDU set SN. In some embodiments, the PDU set related information is in an RLC header and/or a F1-U header of the first wireless communication device when the method for packet discarding is performed by the RLC entity of the first wireless communication device. In some embodiments, the PDU set based status report is used for RLC AM DRBs and/or RLC UM DRBs. In some embodiments, for the PDU set based status report, status PDUs is sent by an AM RLC entity or an UM RLC entity of the second wireless communication device to its peer AM RLC entity or peer UM RLC entity of the first wireless communication device to provide positive and/or negative acknowledgements of RLC SDUs or portions of the positive and/or negative acknowledgements of RLC SDUs.

In some embodiments, triggers to initiate the PDU set based status report by the AM RLC entity or the UM RLC entity of the second wireless communication device comprise that the dependent PDU set is lost or unsuccessfully delivered. In some embodiments, when the PDU set based status report is triggered by the AM RLC entity or the UM RLC entity of the second wireless communication device, at least one following operation is performed by an AM RLC entity or UM RLC entity of the first wireless communication device: considering for each RLC PDU of the PDU set, if any, NACK_SN as unsuccessfully delivered or lost; and/or when a PDU set type of the PDU set which an unsuccessfully delivered or lost RLC PDU belonging to is an I PDU set type, discarding all the RLC SDUs of the associated PDU set according to the dependent PDU set SN.

FIG. 15 is a block diagram of an example system 700 for wireless communication according to an embodiment of the present disclosure. Embodiments described herein may be implemented into the system using any suitably configured hardware and/or software. FIG. 15 illustrates the system 700 including a radio frequency (RF) circuitry 710, a baseband circuitry 720, an application circuitry 730, a memory/storage 740, a display 750, a camera 760, a sensor 770, and an input/output (I/O) interface 780, coupled with each other at least as illustrated. The application circuitry 730 may include a circuitry such as, but not limited to, one or more single-core or multi-core processors. The processors may include any combination of general-purpose processors and dedicated processors, such as graphics processors, application processors. The processors may be coupled with the memory/storage and configured to execute instructions stored in the memory/storage to enable various applications and/or operating systems running on the system.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

1. A method for packet discarding performed by a first wireless communication device, comprising:
transmitting, by the first wireless communication device, a protocol data unit (PDU) with a PDU set related information in a PDU header to a second wireless communication device, wherein the PDU set related information is used for the second wireless communication device to know which PDU set the PDU belongs to and which PDU set is its dependent PDU set;
detecting, by the first wireless communication device, a PDU set based status report transmitted by the second wireless communication device when a PDU of the dependent PDU set is lost or unsuccessfully delivered, wherein the PDU set based status report indicates that the dependent PDU set is lost or unsuccessfully delivered; and
discarding, by the first wireless communication device, a service data unit (SDU) belonging to a PDU set associated with the dependent PDU set when detecting the PDU set based status report;
wherein the method for packet discarding is performed by a packet data convergence protocol (PDCP) entity or a radio link control (RLC) entity of the first wireless communication device.

2. The method for packet discarding according to claim 1, wherein the dependent PDU set can be a I PDU set, and/or a P PDU set, and/or a B PDU set, when the at least one I PDU set is lost or unsuccessfully delivered, at least one associated P PDU set and/or at least one associated B PDU set is discarded, or when the at least one P PDU set is lost or unsuccessfully delivered, the at least one associated B PDU set is discarded.

3. The method for packet discarding according to claim 1, wherein the PDU set related information comprises at least one of the followings: a PDU set type, a PDU set sequence number (SN), a start and/or an end of the PDU set, the PDU SN within the PDU set, a number of PDUs within the PDU set, a PDU set importance and/or dependency, a packet priority in the PDU set, a position indicator (PI), a dependent data radio bearer (DRB) identifier (ID), and a dependent PDU set SN.

4. The method for packet discarding according to claim 1, wherein associated PDU sets are mapped to the same DRB or different DRBs.

5. The method for packet discarding according to claim 4, wherein when the associated PDU sets are mapped to the same DRB and the method for packet discarding is performed by the PDCP entity of the first wireless communication device, the PDU set related information comprises at least one of the followings: the PDU set type, the PDU set SN, the PDU SN within the PDU set, the packet priority in the PDU set, the PI, and the dependent PDU set SN.

6. The method for packet discarding according to claim 4, wherein when the associated PDU sets are mapped to the different DRBs and the method for packet discarding is performed by the PDCP entity of the first wireless communication device, the PDU set related information comprises at least one of the followings: the PDU set type, the PDU set SN, the PDU SN within the PDU set, the packet priority in the PDU set, the PI, the dependent DRB ID, and the dependent PDU set SN.

7. The method for packet discarding according to claim 6, wherein the dependent DRB ID is configured by a control plane mechanism.

8. The method for packet discarding according to claim 7, wherein a radio resource control (RRC) reconfiguration procedure is used by one of the first wireless communication device and the second wireless communication device to inform the dependent DRB ID to the first wireless communication device and the second wireless communication device wherein a DRB is established.

9. The method for packet discarding according to claim 6, wherein based on the PDU set based status report, the PDCP entity of the first wireless communication device is configured to inform an dependent transmitting PDCP entity of the lost dependent PDCP PDU set according to the dependent DRB ID.

10. The method for packet discarding according to claim 9, wherein the dependent transmitting PDCP entity is configured to discard the PDCP SDU belonging to the PDU set associated with the dependent PDCP PDU set.

11. The method for packet discarding according to claim 4, wherein for acknowledged mode (AM) DRBs or unacknowledged mode (UM) DRBs configured by at least one upper layer to send the PDU set based status report by the second wireless communication device, the PDU set based status report is triggered by the second wireless communication device when the dependent PDU set is lost or unsuccessfully delivered and/or t-Reordering expires.

12. The method for packet discarding according to claim 4, wherein when the PDU set based status report is triggered by the second wireless communication device, at least one following operation is performed by the second wireless communication device:
compiling the PDU set based status report by:
setting a first mission packet (FMP) field to a first unsuccessfully received PDU set SN;
setting in a bitmap field as a first value for not all PDCP SDUs of the PDU set that have been received or the PDCP SDUs for which decompression have failed;
setting in the bitmap field as a second value for all PDCP SDUs of the PDU set that have been received; and/or
submitting the PDU set based status report to at least one lower layer as a first PDCP PDU for transmission via the PDCP entity of the first wireless communication device.

13-27. (canceled)

28. A method for wireless communication performed by a gNodeB central unit (gNB-CU), comprising:
transmitting a protocol data unit (PDU) set related information to a gNodeB distributed unit (gNB-DU) on a F1-user interface (F1-U interface), wherein the PDU set related information comprises at least one of following: a PDU set sequence number, a PDU sequence number in a PDU set.

29. The method according to claim 28, wherein the PDU set sequence number is used to indicate a number of a corresponding PDU set.

30. The method according to claim 28, wherein the PDU sequence number in the PDU set is used to indicate a number of a corresponding PDU contained in the PDU set.

31. The method according to claim 28, wherein the PDU set related information is added in a F1-U header.

32. A gNodeB central unit (gNB-CU), comprising:
a transmitter configured to transmit a protocol data unit (PDU) set related information to a gNodeB distributed unit (gNB-DU) on a F1-user interface (F1-U interface), wherein the PDU set related information comprises at least one of following: a PDU set sequence number, a PDU sequence number in a PDU set.

33. The gNB-CU according to claim 32, wherein the PDU set sequence number is used to indicate a number of a corresponding PDU set.

34. The gNB-CU according to claim 32, wherein the PDU sequence number in the PDU set is used to indicate a number of a corresponding PDU contained in the PDU set.

35. The gNB-CU according to claim 32, wherein the PDU set related information is added in a F1-U header.
